(19) United States
(12) Patent Application Publication
(10) Pub. No.: US 2004/0131122 A1
(43) Pub. Date: Jul. 8, 2004

(54) Encoding device and encoding method

(76) Inventor: Kei Kudo, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/730,001

(22) Filed: Dec. 9, 2003

(30) Foreign Application Priority Data
Dec. 9, 2002 (JP) 2002-356451

(51) Int. Cl. H04N 7/12

(52) U.S. Cl. 375/240.16; 375/240.01; 348/699

(57) ABSTRACT

An encoding device and encoding method intended to reduce the total processing time are provided. Basic parameters are generated from plural parameters which are set. Motion prediction is made according to the basic parameters. Further, the motion prediction result is converted according to the encoding parameters of each encoder. The conversion results are respectively output to the corresponding encoders.

### BACKGROUND

The present invention relates to an encoding device that generates a plurality of compressed image data from one image data and outputs the generated image data and an encoding method.

In conventional motion picture encoding devices, high compression efficiency is realized by encoding inter-frame differences. Inter-frame differences are called motion vectors whereas motion vector detection is called motion prediction. There are a number of methods for motion vector prediction. Generally, the block matching method is used. To generate compressed motion picture data in multiple formats from one picture data, the encoding device must have a plurality of encoders and use them to generate respective compressed motion picture data. In addition, it is necessary for each encoder to perform compression processing with motion vectors adapted to its encoding format.

If motion prediction is performed for each encoder as in the above-mentioned encoding device, the amount of encode processing by all encoders increases enormously as the number of encoders, or the number of needed output compressed picture data, increases. The increased amount of encode processing enlarges the total processing time. In addition, as the number of output compressed picture data increases, more encoders must be added, which raises the cost.

Therefore, according to a technique disclosed in Japanese Patent Laid-open No. 2002-344972, a plurality of motion picture encoding devices, which differ in resolution, have a simple motion vector detection unit. Independent of the encoders, this simple motion vector detection unit detects vectors at a resolution lower than the encoding resolution of each encoder. Before encoding in each encoder, simple motion vectors that are expanded to its encoding resolution are used to search narrow regions and re-detect the motion vectors at its encoding resolution. According to Japanese Patent Laid-open No. 2002-344972, a simple motion vector detection unit may be incorporated in an encoder that encodes pictures at the lowest resolution. In this configuration, the encoder which incorporates the simple motion vector detection unit directly uses detected simple motion vectors as motion vectors whereas the other encoders, like in the former configuration with a separated simple motion vector detection unit, re-detect motion vectors at their encoding resolutions.

However, taken into consideration in the technique disclosed in Japanese Patent Laid-Open No. 2002-344972 are only differences of resolution among the compressed motion pictures to be generated. In addition, since the simple vector detecting resolution is determined by taking into consideration the motion vector search method, it is not possible to realize optimum high speed encoding if motion picture data is converted in terms of another format parameter.

### SUMMARY

It is an object of the present invention to reduce the total processing time in an encoding device and method which generates encoded data in plural formats. It is another object of the present invention to reduce the time of processing required to accurately generate compressed moving picture data in plural formats.

According to the present invention, there is provided an encoding device and encoding method wherein: plural parameters are set; basic parameters for motion prediction are generated from the set plural parameters; motion prediction processing is performed by using the generated basic parameters; the motion prediction result is converted according to the encoding parameters of plural encoders; and the conversion results are respectively output the plural encoders.

### BRIEF DESCRIPTION OF THE DRAWINGS

FIG. 1 is the block diagram of an encoding device according to an embodiment;

FIG. 2 is the block diagram of a decoder according to the embodiment;

FIGS. 3A and 3B are flowcharts of processing for decoding and encoding;

FIG. 4 is the block diagram of an encoder according to the embodiment;

FIG. 5 is an example of a parameter setting GUI;

FIG. 6 is a flowchart of processing by a motion prediction processor;

FIG. 7 is the block diagram of an encoding device according to another embodiment;

FIG. 8 is a flowchart of another processing by a motion prediction processor; and

FIG. 9 is a flowchart of a prioritizing process according to the embodiment.

### DETAILED DESCRIPTION

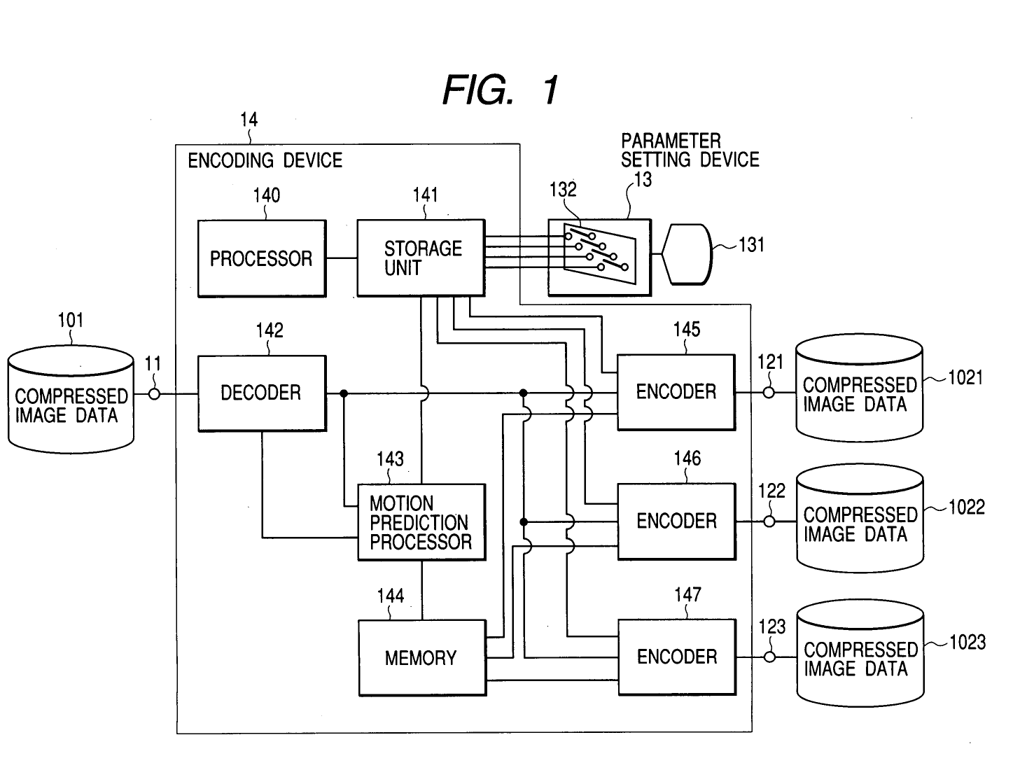

FIG. 1 is a block diagram showing a configuration of an encoding system. The encoding system in FIG. 1 includes a data supply device 101, data storage devices 1021 to 1023, a parameter-setting device 13 and an encoding device 14. It is assumed in the following description that compressed image data, e.g., MPEG2 data, are converted to plural MPEG4 compressed image data in different formats.

The data supply device 101 supplies original image data, which is to be encoded into a plurality of formats. The data storage devices 1021 to 1023 receive the encoded image data in a plurality of formats from the encoding device 14 and store them therein. The data supply device 101 and data storage devices 1021 to 1023 are each one or a plurality of non-volatile storage devices. For example, they are embodied either by hard disks and other magnetic recording devices or by DVD-RAM, DVD-R and other DVD recorders. Further, the data supply device 101 may also be implemented by such an image pickup device as a digital video camera. In this case, non-compressed data may be supplied as original data.

The parameter setting device 13 inputs information specifying formats in which compressed image data are to be created by the encoding device 14. The parameter setting device 13, as described later, can be implemented by an input device 131 such as a keyboard or mouse, a display device and a parameter setting GUI program.

The encoding device 14 has an input terminal 11 to receive compressed image data 101 and a plurality of output terminals 121, 122 and 123 to output a plurality of compressed image data 1021, 1022 and 1023, respectively. In addition, the encoding device 14 includes a processor 140, a storage unit 141, a decoder 142, a motion prediction processor 143, a memory 144 and a plurality of encoders 145, 146 and 147. The encoding device 14 is implemented through execution of software by an information processing apparatus such as a personal computer.

The processor 140 controls each unit of the encoding device and performs processing based on the data stored in the storage unit 141. The processor 140 is implemented by a CPU in an information processing apparatus, a MPU on an encoder board or the like.

Connected to the parameter-setting device 13, the storage unit 141 stores parameters which are entered from the parameter-setting device 13. The storage unit 141 can be implemented either by a main memory in an information processing apparatus or by such a memory as a non-volatile memory or a hard disk.

Connected to the input terminal 11, the decoder 142 produces non-compressed image data by decoding compressed image data (e.g., MPEG-2 image data) that has been compressed at a high compression rate. To the motion prediction processor 143, the decoder 142 outputs motion vectors that are to be used in decoding compressed image data. The motion prediction processor 143 uses the motion vectors to produce motion vectors required in encoding.

The motion prediction processor 143 is connected to the storage unit 141 and decoder 142. By using a plurality of parameters stored in the storage unit 141, the motion prediction processor 143 determines basic parameters for predicting motions. In addition, by using the determined basic parameters, the motion prediction processor 143 performs motion prediction processing on the non-compressed image data from the decoder 142. The processing by the motion prediction processor 142 will be described later.

Connected to the motion prediction processor 143, the memory 144 stores the result of the motion prediction processing. In the motion prediction processing, it is judged whether points moved in a predictable range. Further, the prediction result is supplied to the encoders 145 to 147 connected to the memory 144. The memory 144 can be implemented by, for example, a main memory in an information processing apparatus.

In formats specified by the parameter-setting device 13, the encoders 145 to 147 each compress image data. The encoding device 14 in FIG. 1 is configured to have three encoders. The number of encoders is not limited to three. The present invention is applicable to an encoding device provided with at least two encoders.

The encoders 145, 146 and 147 are each connected to the decoder 142, storage unit 141 and memory 144. By using the plurality of parameters stored in the storage unit 141 and the result of motion prediction processing stored in the memory 144, the encoders each encodes the non-compressed image data from the decoder 142 to produce compressed image data. The compressed image data are respectively output to the plurality of output terminals 121, 122 and 123.

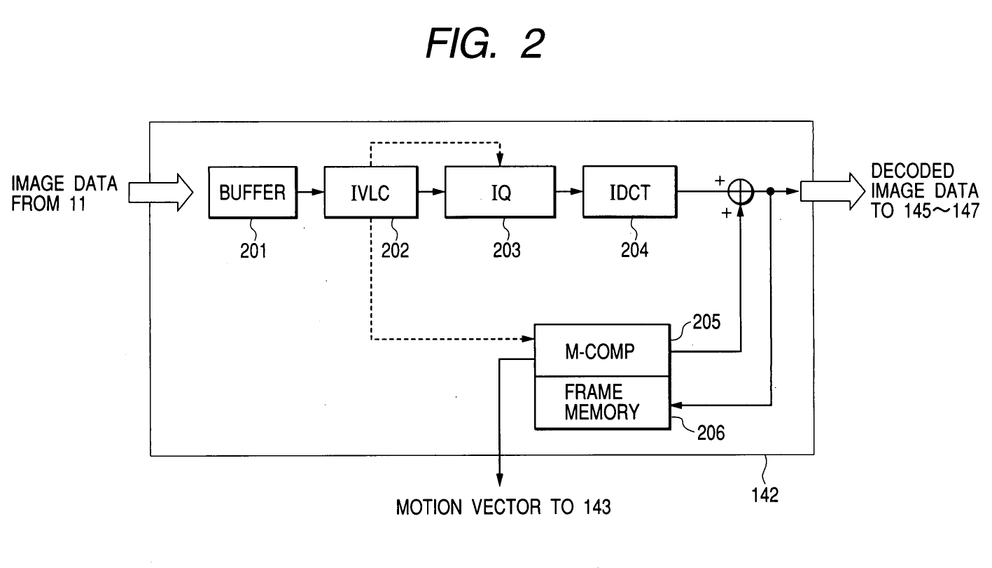

FIG. 2 is a block diagram of the decoder 142. The decoder can be implemented either by a discrete hardware decoder board or by software.

The decoder 142 includes a buffer 201, an IVLC 202, an inverse quantizer or IQ 203, an IDCT unit 204, a motion compensation unit 205 and a frame memory 205. The buffer 201 temporally stores the compressed image data received from the input terminal 11. The IVLC 202 performs variable length decoding processing on the variable length compressed data in order to transform the data to a DCT format. The IQ 203 dequantizes the quantized code. The IDCT unit 204 restores the data sequence by using the inverse discrete cosine coefficients. The motion compensation unit 205 performs motion compensation by using motion prediction vectors obtained by the variable length decoding processing. The frame memory 206 stores frame data on which motion compensation is to be performed.

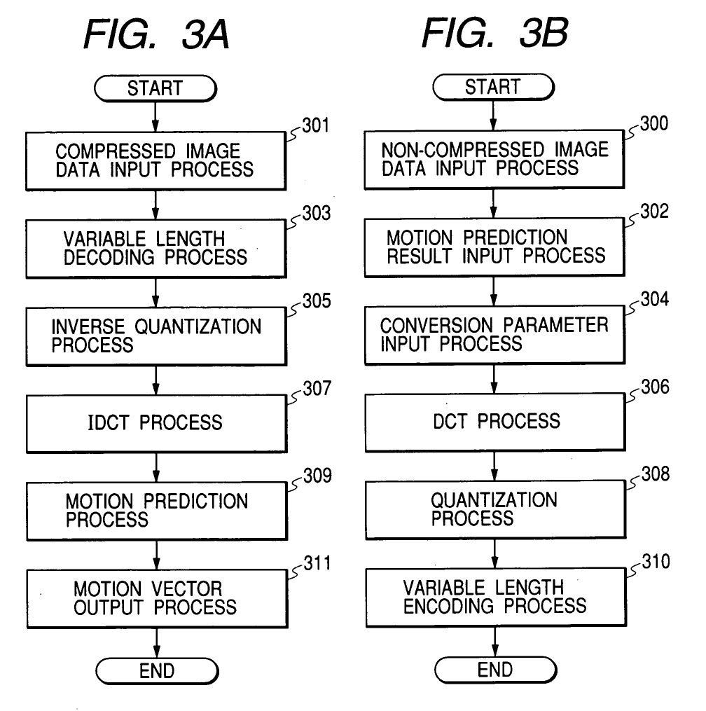

FIG. 3A shows how decoding processing is performed in the decoder 142. Firstly, the buffer 201 temporally stores input compressed image data (Step 301), the IVLC 202 executes a variable length decoding process (Step 303) and the IQ 203 executes an inverse quantization process (Step 305). Then, the IDCT unit executes an inverse discrete cosine transform process (Step 307). Meanwhile, after the variable length decoding process is done, the motion compensation unit extracts a motion prediction vector and performs motion compensation (Step 309). The motion compensation result and the IDCT processing result are logically summed to obtain non-compressed image data. Then, the non-compressed image data is transmitted to the encoders 145 to 147. In addition, the motion vector generated from the compressed data are supplied by the motion compensation unit 205 to the motion prediction processor 143 (Step 311).

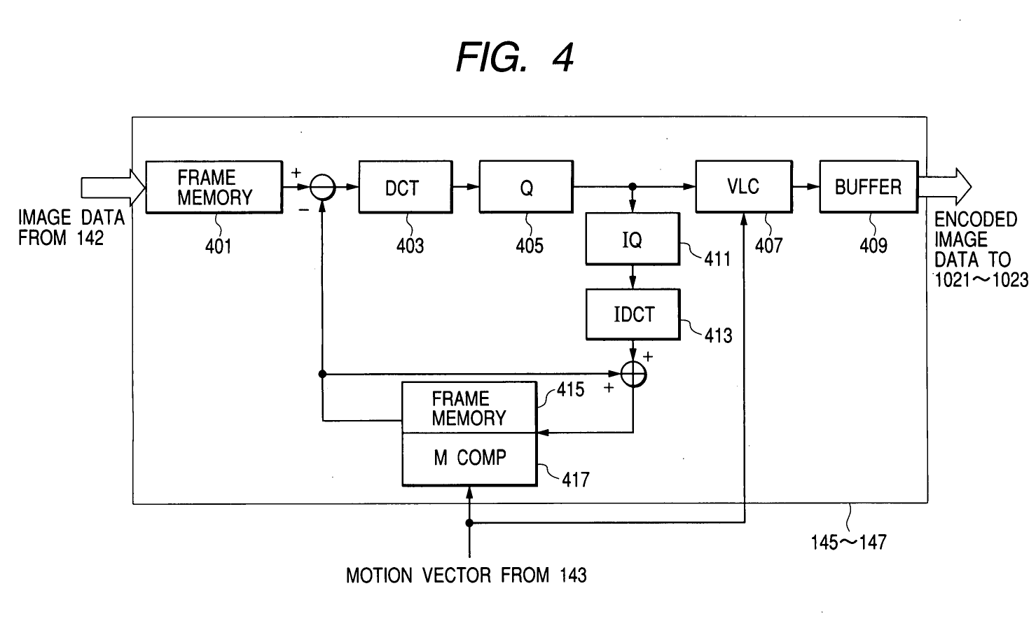

FIG. 4 shows a configuration of each of the encoders 145 to 147. Each encoder can be implemented either as discrete hardware or by software.

The encoder in FIG. 4 has frame memories 401 and 415, a DCT unit 403, a quantization unit 405, a VLC unit 407, a buffer 409, an inverse quantization unit 411, an IDCT unit 413 and a motion compensation unit 417. Although each unit of the encoder in FIG. 4 has the same function as the corresponding unit of a prior art encoder, the encoder of FIG. 4 includes no motion prediction unit. The encoder of FIG. 4 acquires motion vectors from the motion prediction unit 13 outside the encoder and performs motion compensation and so on by using the acquired motion vectors.

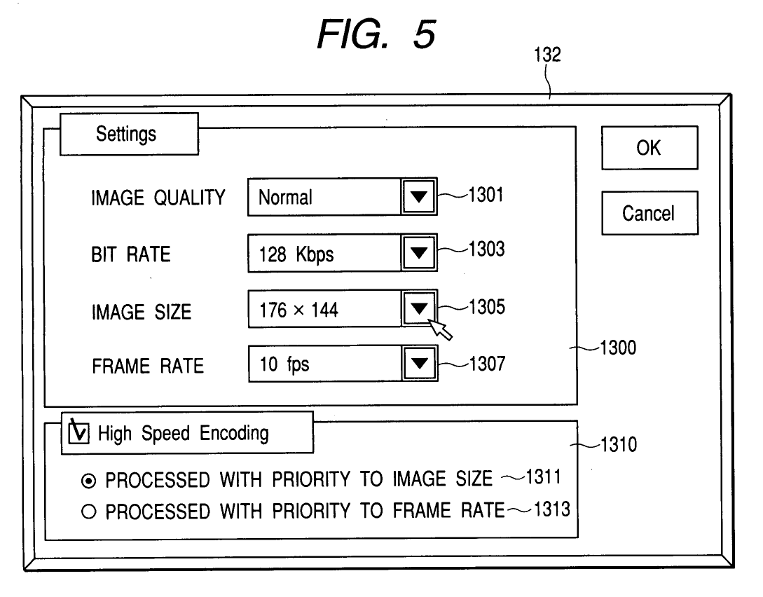

The parameter setting device 13 is described below with reference to FIG. 5. In the parameter setting device 13, a plurality of parameters are set for generating a plurality of compressed image data 1021, 1022 and 1023 which are to be output respectively to the plural output terminals 121, 122 and 123. For the plural compressed image data 1021, 1022 and 1023 to be generated by the encoders 145, 146 and 147, respectively, it is necessary to set a plurality of parameters, including frame rate, image size and bit rate, for each of the encoders 145, 146 and 147 respectively. These parameters are set by the parameter setting unit 13.

Shown in FIG. 5 is a screen on a display unit 132. The parameter setting device 13 displays the setting screen of FIG. 5, urging the operator to enter settings. The setting screen has a format setting area 1300 for setting a format in which compressed image data is to be generated and a priority setting area 1301 for setting a priority for high-speed compression processing. Note that although only one format setting area 1300 is shown in view of description, there are provided as many format setting areas as the encoded data to be generated.

For example, in the case of the MPEG4 which allows a plurality of formats, each parameter in the format setting area 1300 provides choices as follows: The image quality can be chosen from options high, normal and low 1301. The bit rate options 1303 allow the operator to set the bit rate to any specific value between 5K bps and 38.4M bps. The image size can be chosen from such options 1305 as 6 pixels×120 lines, 240 pixels×76 lines, 320 pixels×240 lines and 352 pixels×240 lines. The frame rate options 1307 allow the operator not only to choose from 24 fps, 25 fps, 29.97 fps, 50 fps and 60 fps but also to manually enter a specific rate.

The priority setting area 1310 is an area for specifying which parameter is to be given priority when motion vectors are processed before passed to the encoders. That is, the motion prediction processor 143 detects only one vector value at a time. This motion vector value must be processed before passed to each of the encoders. From the image format parameters according to which image data is compressed by each encoder, one parameter must be selected which is to be given priority when vectors are processed. In the case of the priority setting area 1310 in FIG. 5, it is possible to give priority to either image size or frame rate for processing.

To consider how the setting should be, assume that image data with a resolution of 252 pixels×240 lines is input at a frame rate of 25 fps and only the image size is changed. If the input image data is translated in format to 352 pixels×240 lines, same as the original image data, and 176 pixels×120 lines in terms of resolution, giving priority to the image size is preferable since what is required is only to detect motion vectors from one image data stream and curtail or expand them. Meanwhile, if the image data is translated to 25 fps and 50 fps in terms of frame rate regardless of the resulting image size, giving priority to the frame rate is preferable since what is required is only to detect motion vectors from the 50 fps data stream and curtail them to a half for the 25 fps data stream.

By using the setting screen of FIG. 5, the operator sets various parameters and priority through an input unit 133. For example, the input unit 133 may be configured either as a mouse with a pull down or as a keyboard. The entered parameter and priority settings are retained in the storage unit 141.

Note that the format of the pre-encode image data is specified by using another screen which resembles the setting screen of FIG. 5. That is, the embodiment is configured so as to specify the format parameters of the image data which is to be input to and encoded in the encoding device 14. The entered parameters are stored in the storage unit 141.

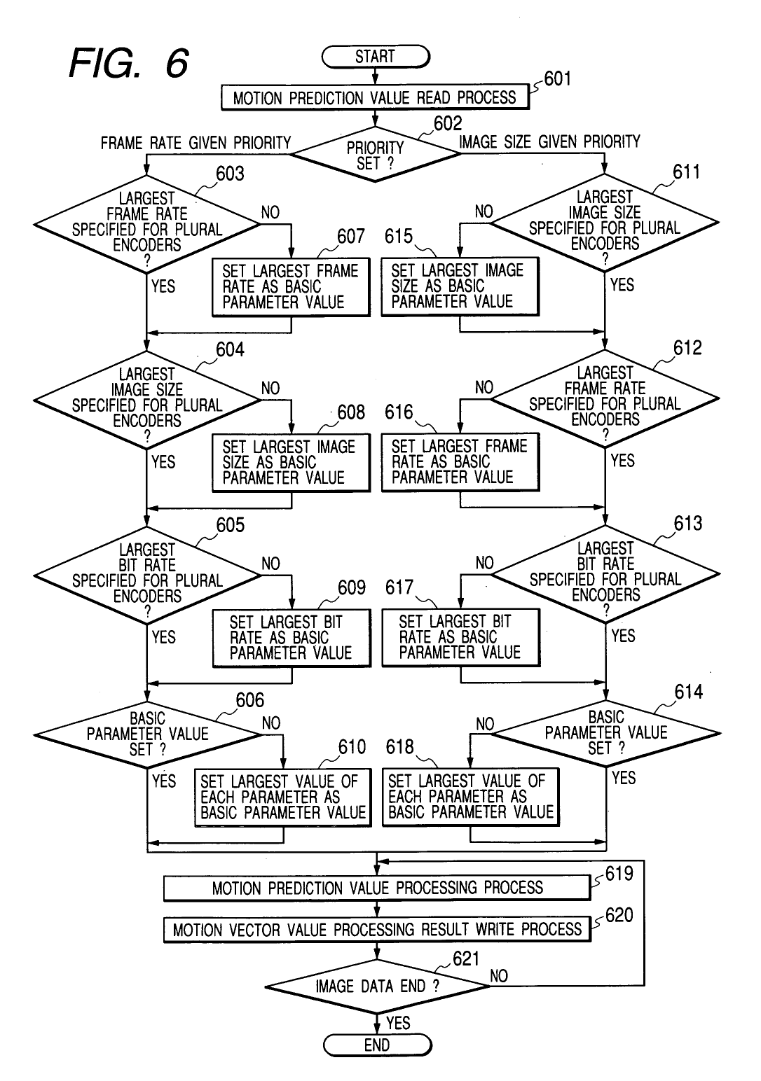

FIG. 6 shows how processing is performed in the motion prediction processor 143. The motion prediction processor 143 reads in the parameter (frame rate, image size and bit rate) and priority settings retained in the storage unit 141 (Step 601). As many sets of these settings as the compressed image data to be generated are stored. According to the priority setting read therefrom, it is judged whether priority is to be given to the frame rate or the image size in Step 602. If no priority setting has been done by the parameter setting device 13, priority is given to the frame rate. This is because generally the image size is changed more often than the frame rate by format transformation. Note that the embodiment may also be configured in such a manner as to urge the operator to set priority if no priority setting is entered.

Firstly, if priority is given to the frame rate, a frame rate check process 603 is executed. The set frame rate values are checked to judge whether more than one settings are equal to the same largest value. If more than one frame rates are set to the same largest value, processing proceeds to a size check process 604. If one frame rate is set to the largest value, processing proceeds to Step 617 which stores the largest frame rate value in the storage unit 141 as the basic parameter value and goes back to an image size check process 604.

The image size check process 604 checks if more than one image size settings are equal to the same largest value. If plural image sizes are set to the same largest value, processing proceeds to a bit rate check process 605. If only one image size is set to the largest value, processing proceeds to Step 609. In Step 609, the largest image size value is stored in the storage unit 141 as the basic parameter value. After step 609, processing proceeds to the bit rate check process 605.

If the bit rate check process 605, if more than one bit rate settings are equal to the same largest value, the largest bit rate value is determined as the basic parameter value before processing proceeds to Step 606. If one bit rate is set to the largest value, processing proceeds to Step 610 which stores the largest bit rate value in the storage unit 141 as the basic parameter value.

In step 606, it is judged whether the basic parameter values have been set. If so, processing proceeds to a motion prediction value processing process (Step 619). If not, the same largest value shared by plural settings entered for each parameter is stored as the basic parameter value in the storage unit 141.

On the other hand, if it is detected in the priority setting judgment 602 that priority is given to the image size, processing goes to Step 611. The order in which the check processes are performed is different from that taken when priority is given to the frame rate. When priority is given to the image size, the image size check process 611 is executed at first.

In the image size check process 611, a check is made if more than one image size settings are equal to the same largest value. If a plurality of image sizes are set to the same largest value, processing proceeds to the frame rate check process 612. If only one image size is set to the largest value, processing proceeds to Step 615. In Step 615, the largest image size value is stored in the storage unit 141 as the basic parameter value. After step 615, processing proceeds to the frame rate check process 612.

In the frame rate check process 612, the set frame rates are judged as to whether more than one settings are equal to the same largest value. If more than one frame rates are set to the same largest value, processing proceeds to the bit rate check process 613. If one frame rate is set to the largest value, processing proceeds to Step 616 where the value is stored in the storage unit 141 as the basic parameter value, and goes back to the bit rate check process 613.

In the bit rate check process 613, the set bit rates are judged whether more than one bit rate settings are equal to the same largest value. If so, processing proceeds to Step 614. If only one bit rate is set to the largest value, processing proceeds to Step 617 where the value is stored in the storage unit 141 as the basic parameter value, and proceeds to Step 614.

In step 614, it is judged whether a basic value has been set to each parameter. If so, processing proceeds to the motion prediction value processing process (Step 619). If not, the same largest value shared by plural settings entered for each parameter is stored as the basic parameter value in the storage unit 141.

In the motion prediction value processing process 619, a motion vector read from the decoder 142 is processed according to each basic parameter value stored in the storage unit 141. That is, the motion vector of the image data to be encoded is supplied to the motion prediction processor 143 from the decoder. If the format of the compressed image data entered from the image data supply device 101 is different from the encoding format, the motion vector must be processed according to the encoding format.

The motion prediction result by the motion prediction processor can be used as it is if the pre-encode image size is same as the post-encode image size. If the image size differs, the processing result can also be used by taking into consideration the expanding/reducing rate. If the image size of the input compressed image data 101 is larger than the image sizes of the output compressed image data 1021 to 1023, the motion prediction values are reduced according to the image size ratios. If the image size of the input compressed image data 101 is smaller than the image sizes of the output compressed image data 1021 to 1023, the motion prediction values are enlarged according to the image size ratios. If the image size of the input compressed image data 101 is equal to the image size of any of the output compressed image data 1021 to 1023, execution of the motion prediction value processing process 608 is omitted.

If the frame rate is converted, the motion vector is processed according to the frame rate conversion. That is, if the set frame rate is larger than the frame rate of the original frame rate, division by the frame rate conversion ratio is performed. Reversely if the set frame rate is smaller than the frame rate of the original frame rate, the motion vector is enlarged by multiplying it by the frame rate conversion ratio. By this processing, it is possible to adapt the motion vector to the changed number of frames per second.

The picture pattern after conversion is determined by the encoder. If only the frame rate is changed, the picture pattern before conversion can be more followed, which further reduces the processing time.

Then, a motion vector processing result write process 620 writes each converted motion vector to the memory 144. The memory 144 has areas where motion vectors are stored for the encoders 145 to 147 respectively, allowing the encoders 145 to 147 to perform encoding processing by using motion vectors stored therein. The motion vector processing process 619 and vector value processing result write process 620, mentioned above, are performed repeatedly until the end of the image data (Step 621).

FIG. 3B is a flowchart of processing by the encoders 145, 146 and 147. Since each encoder performs the same processing, the encoder 145 is mentioned in the following description. The encoder 145 (146, 147) begins encoding the non-compressed image data from the decoder 142, that is, performing decoding when the generation of a motion prediction result is complete in the motion prediction processor 143.

Firstly, in a compressed image data input process 300, the encoder 145 reads in non-compressed image from the decoder 142. Then, in a prediction result input process 302, the encoder 145 reads out motion prediction result information from the memory 144, and followed by a conversion parameter input process 304, the encoder 145 reads out the set conversion parameters from the storage unit 141. Then, the encode 145 performs a DCT (Discrete Cosine Transform) process 306, quantization process 308 and variable length encoding process 310 on the received non-compressed data and motion prediction result information according to the set conversion parameters. The compressed image data 1021 (1022, 1023) (e.g., MPEGG-4 image data) compressed in this manner is generated and output to the output terminal 121 (122, 123).

Many components 142, 143, 144, 145, 146, 147 of the encoding device 14 are shown in FIG. 1. It is not necessary to implement these components by hardware. Their operations may be achieved by software, too. In addition, although the embodiment is configured so as to store converted motion vectors in the memory 144, the configuration may also be modified so as to directly output them to the respective encoders 145 to 147 from the motion prediction processor 143. In this case, the memory 144 may be omitted if each encoder is provided with a buffer area to temporary store received motion vectors.

As mentioned above, each encoder does not perform motion prediction. Instead, the motion vectors to be used by the encoders 145, 146 and 147 are calculated by the motion prediction processor. The motion prediction processor generates one basic parameter and performs motion prediction according to the generated basic parameter value. Further, it converts a calculated motion vector into a parameter according to each of the encodings of the respective encoders. The basic parameter is generated so that the motion vector can easily be converted in line with the processing by each encoder. For this purpose, a GUI is used to specify a parameter that is to be given priority as the basic parameter. That is, the basic parameter is specified before motion prediction and the encoders 145, 146 and 147 use motion vectors that are obtained by adapting the motion prediction result to their respective formats. This makes it unnecessary for each encoder to perform motion prediction processing, which can reduce the total processing time.

In addition, although encoders must be added as the number of output compressed data increases, it is possible to suppress the cost up of the encoders since they do not incorporate the unnecessary motion prediction feature. Further, accurate motion prediction and encoding can be performed although each encoder has no motion prediction unit.

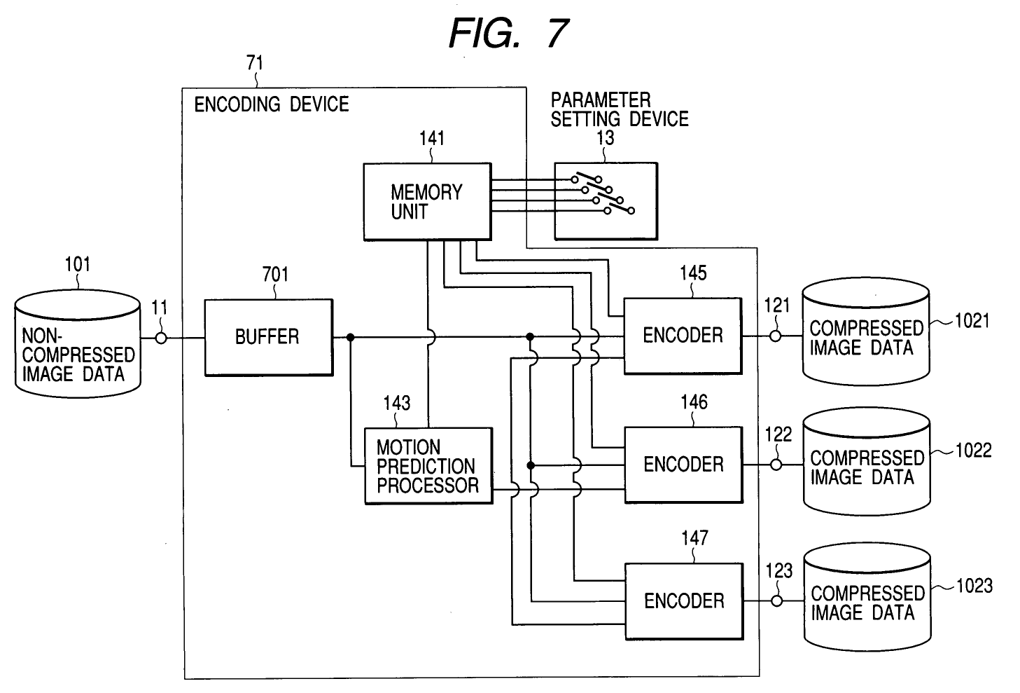

Although in the description so far, it is assumed that the input image data is compressed data, the input image data must not be encoded data. For example, it is possible that non-compressed image data may directly be output to an encoding device from digital video equipment and encoded to a plurality of formats. FIG. 7 shows a block diagram of such a encoding device 71. The encoding device of FIG. 7 is configured so as to directly transmits converted motion vectors to encoders 145 to 147.

In FIG. 7, non-compressed image data is encoded to a plurality of formats. Therefore, such a decoder as that in the encoding device 14 of FIG. 1 is not necessary. Instead, a buffer 701 is provided to temporary store the non-compressed image data received from a data supply device 101. In addition, the motion prediction processor 143 in the encoding device 71 of FIG. 7 must generate a reference motion vector by using the non-compressed data from the buffer 701 whereas a motion vector is extracted from the decoder in the encoding device 14 of FIG. 1.

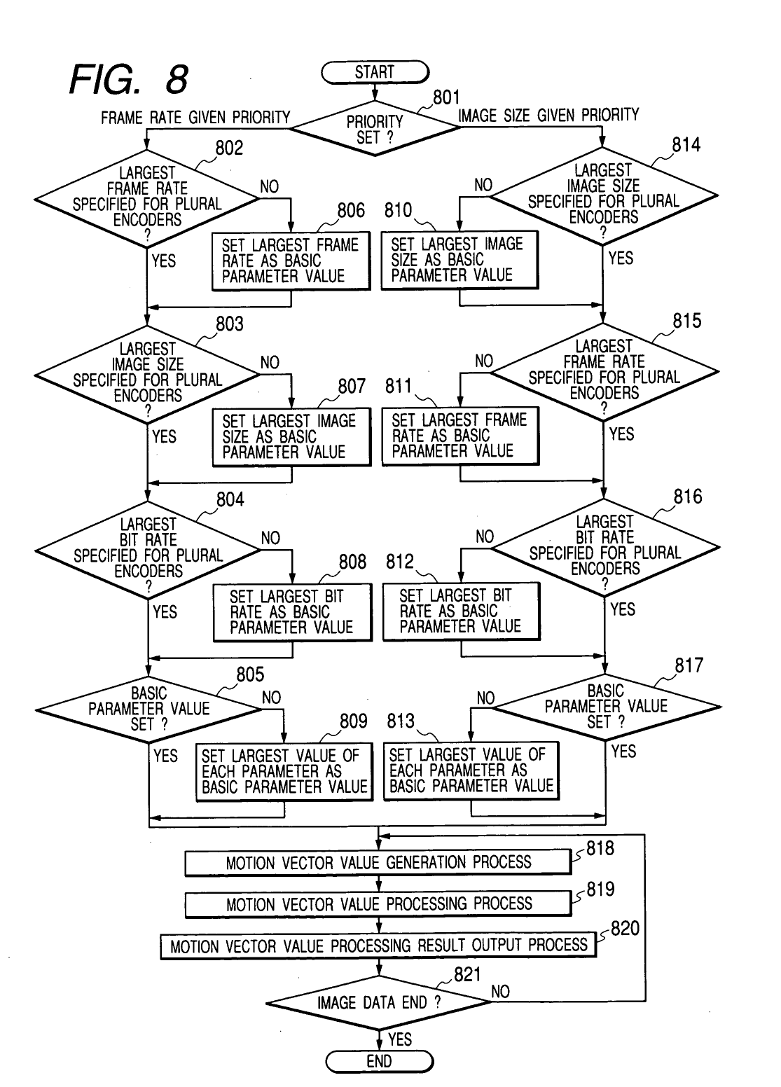

FIG. 8 shows the flows of processing by the motion prediction processor 143 in the encoding device 71. The priority setting procedure 801 to 817 in FIG. 8 is similar to the procedure 602 to 619 in FIG. 6. One difference between them is that the motion prediction value read process 601 of FIG. 6 is not found in FIG. 8 while a motion prediction value generation process 818 is added in FIG. 8. This is because motion vectors must be generated by the motion prediction processor 143 since the encoding device of FIG. 7 has no decoder.

Accordingly, the motion prediction processor 143 generates a motion vector in a single format by using each basic parameter set by the priority setting procedure 801 to 817. This format may or may not be the same as the encoding format of one of the encoders 145 to 147. This is because the basic parameters are set so as to facilitate the conversion to the respective formats. Then, the generated motion vector is converted to the respective formats by a motion vector processing process 819.

Another difference between the processing flows of FIG. 8 and those of FIG. 6 is that a motion vector value output process 820 is included in FIG. 8 instead of the motion vector value processing result write process 620. This is because motion vector values are respectively output to the encoders 145 to 147 since the encoding device 71 does not have such a storage device as denoted at reference numeral 144. Therefore, if the encoding device 71 has a memorory 144 similar to the encoding device 14, a motion vector value processing result write process 820 is performed likewise in FIG. 6.

Also in the case of the encoding device 71 of FIG. 7, a single format is determined for motion vectors to be calculated. This configuration makes it possible to efficiently generate compressed image data in plural formats.

Note that although a GUI is used for priority setting as part of the vector calculation format determination system is FIG. 1, this configuration may also be modified so as to automatically perform priority setting. That is, an information processing apparatus on which the encoding device 14 is implemented can be configured so as to perform priority setting by a software process.

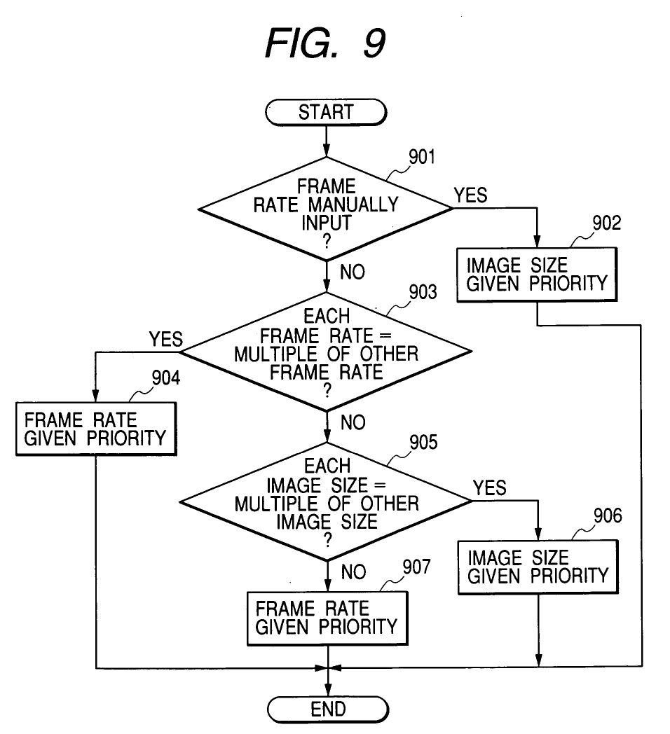

FIG. 9 is a flowchart of such a priority setting process. This priority setting process is configured so as to be executed before encoding is performed after the parameters are set by the parameter setting device 13. However, the process may be executed any time after the format of input image data and the formats of compressed images data to be generated by the encoders are entered/specified via the parameter setting device 13. For example, the process may be configured so as to be executed before motion vector generation is started in the motion prediction processor.

Firstly in the priority setting process, it is judged whether of the format parameters of pre-encode and post-encode image data, the frame rate was manually entered (Step 901). This is because the MPEG4 allows the frame rate to be set freely in the prescribed range. If the frame rate was entered manually, the image size is given priority (Step 902). This is because motion vectors at a manually specified frame rate are more likely to require complicate processing for conversion than those at a frame rate selected from the specific ones. If no frame rate was entered manually, the pre-encode and post-encode formats are judged whether any other frame rate setting is a multiple of the smallest frame rate setting or whether more than one settings share the same smallest frame rate value (Step 903). If so, the frame rate parameter is given priority (Step 904).

If neither any other frame rate setting is a multiple of the smallest frame rate setting nor more than one settings share the same smallest frame rate value, it is judged whether any other image size setting is a multiple of the smallest image size setting or whether more than one settings share the same smallest image size value (Step 905). If so, the image size parameter is given priority (Step 906). Otherwise, the frame rate parameter is given priority (Step 907).

The process in FIG. 9 makes it possible to smoothly set priority even when the operator is inexperienced. Note that the process of FIG. 9 is configured so as to give precedence to the frame rate. This is because the number of frame rates employed is limited and therefore the frame rate of the input image is less likely to be converted. If the image size is less likely to be converted as compared with the frame rate, the configuration of FIG. 9 may preferably be modified so as to give precedence to the image size over the frame rate.

What is claimed is:

1. An encoding device connected to an input terminal to which encoded image data is input, plural output terminals to which plural encoded image data are output; and a parameter setting device to set plural parameters for generating the plural encoded image data which are respectively output to the plural output terminals, said encoding device comprising:
a storage unit to store the plural parameters which are set by the parameter setting device;
a decoder to generate non-encoded image data by decoding encoded image data which is input from the input terminal;
a motion prediction processor which generates basic parameters from the plural parameters stored in the memory unit and performs motion prediction on the non-encoded image data by using the basic parameters;
a memory to store the result of the motion prediction; and
plural encoders which encode the non-encoded image data to generate compressed image data by using the plural parameters stored in the storage unit and the motion prediction result stored in the memory and output the compressed image data respectively to the plural output terminals.

2. An encoding device which generates encoded data in plural formats, comprising:
an input terminal to which image data to be encoded is input;
plural encoders to generate plural encoded image data in different formats;
an output terminal to output the plural encoded image data generated by the encoders;
an input unit to set plural parameters which define each of the formats in which the image data is to be encoded by the encoders;
a processor to determine a set of basic parameters from the set plural parameters; and
a motion prediction processor which calculates a motion vector by using the set of basic parameters, converts the motion vector according to the parameters set through the input unit and outputs the converted motion vectors which are to be used respectively by the plural encoders.

3. An encoding device which generates encoded data in plural formats according to claim 2 wherein said processor is incorporated in said motion prediction processor.

4. An encoding device which generates encoded data in plural formats according to claim 2, further comprising a display unit to display a setting screen through which said plural parameters are prioritized.

5. An encoding device which generates encoded data in plural formats according to claim 2 wherein said processor also determines which one of said plural parameters is to be given priority.

6. An encoding device which generates encoded data in plural formats according to claim 2, further comprising a decoder to decode encoded data which is input from said input terminal.

7. An encoding device which generates encoded data in plural formats according to claim 2 wherein if the basic parameters set by said processor do not comply with any set format, said motion prediction processor converts the image data according to the basic parameters before performing motion prediction.

8. An encoding device which generates encoded data in plural formats according to claim 2 wherein said plural parameters include an image size and a frame rate.

9. An encoding device which generates encoded data in plural formats according to claim 8 wherein said processor determines the largest values entered for said image size and said frame rate as basic parameter values.

10. An encoding device which generates plural encoded data, comprising:
plural encoders to generate encoded image data in respectively different formats;
an output terminal to output the plural encoded image data generated by the encoders;
an input unit to set plural parameters which define each of the formats in which the image data is to be encoded by the encoders and to prioritize the plural parameters for each format;
a processor to determine a set of basic parameters from the set plural parameters according to the prioritization; and
a motion prediction processor which calculates a motion vector by using the set of basic parameters, converts the motion vector according to the parameters set through the input unit and outputs the converted motion vectors which are to be used respectively by the plural encoders.

11. An encoding device which generates plural encoded data in plural formats according to claim 10 wherein said processor is incorporated in said motion prediction processor.

12. An encoding device which generates plural encoded data in plural formats according to claim 1 wherein the largest value set for each parameter is determined as the a basic parameter value by said processor.

13. An encoding device which generates plural encoded data in plural formats according to claim 10, further comprising:
a display unit through which said plural parameters are set and said plural parameters are prioritized.

14. An encoding device which generates plural encoded data in plural formats according to claim 10, further comprising:
a decoder to decode encoded data which is input from said input terminal.

15. An encoding device which generates plural encoded data in plural formats according to claim 10 wherein if the basic parameters set by said processor do not comply with any set format, said motion prediction processor converts the image data according to the basic parameters before performing motion prediction.

16. An encoding method for an encoding device connected to an input terminal to which encoded image data is input, plural output terminals to which plural encoded image data are output, and a parameter setting device to set plural parameters for generating the plural encoded image data which are respectively output to the plural output terminals, said encoding method comprising the steps of:
storing the plural parameters which are set by the parameter setting device;
generating non-encoded image data by decoding encoded image data which is input from the input terminal;
generating basic parameters from the stored plural parameters and performing motion prediction on the non-encoded image data by using the basic parameters;
storing the result of the motion prediction; and
encoding the non-encoded image data to generate compressed image data by using the stored plural parameters and motion prediction result and outputting the compressed image data respectively to the plural output terminals.
